(19) United States
(12) Patent Application Publication
(10) Pub. No.: US 2003/0034302 A1
(43) Pub. Date: Feb. 20, 2003

(54) Insecticide delivery apparatus and associated methods

(75) Inventors: Patrick M. Anthony, Mt. Dora, FL (US); Parker O. Anthony, Mt. Dora, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: PRECISION CONTROL TECHNOLOGY, INC., Sanford, FL (US)

(21) Appl. No.: 09/933,373

(22) Filed: Aug. 20, 2001

(51) Int. Cl. C02F 3/04

(52) U.S. Cl. 210/615; 210/631; 210/743; 210/96.1; 210/150; 210/198.1

(57) ABSTRACT

An insecticide delivery apparatus may include an insecticide extraction chamber having an outlet adjacent a lower end thereof, and a screen adjacent the outlet for holding a mass of insecticide bearing bodies to partially fill the insecticide extraction chamber. A nozzle may be positioned adjacent an upper end of the insecticide extraction chamber for directing a water stream downwardly therefrom toward the mass of insecticide bearing bodies. An air control device may control the water level and associated head space so that the insecticide bearing bodies are at least partially submerged in the water. The bodies may be churned in the water by action of the stream to enhance delivery of insecticide into the water. The apparatus may provide efficient and cost effective control of a number of insects, such as midge flies, that are prevalent in a trickling filter of a typical wastewater treatment plant.

### FIELD OF THE INVENTION

The invention relates to the field of insect control, and, more particularly, to the field of insect control relating to wastewater processing.

### BACKGROUND OF THE INVENTION

Wastewater treatment plants are commonly used to treat municipal sewage and remove undesired materials before discharge of the treated wastewater. A common wastewater treatment technology uses a trickling filter to help remove certain undesired components of the wastewater. Unfortunately, the trickling filter may create a common insect control problem. In this type of filtering system, the wastewater is re-circulated through trickling filter tanks where microbiological activity cleans the wastewater. Midge flies, also known as filter flies, thrive in the slime layer formed in the trickling filter. If they go untreated, the insects may multiply and create a nuisance to workers and nearby residents. Furthermore, when these insects are in the larva stage, they may inhibit filtering of secondary solids by attracting them to the surface and allowing them to flow over the weirs.

A number of methods are employed by wastewater treatment facilities to combat these pests. Some municipalities flood or chemically treat the slime layer to control the midge files. Unfortunately, this may also kill the beneficial microbes thereby reducing the treatment process efficiency. On the other hand, some municipalities add a liquid insecticide, such as methoprene, to the wastewater treatment process. This chemical attacks the pests in their larva stage and prevents them from becoming adults and breeding without damaging the microbiological activity in the trickling filter. Unfortunately, this liquid insecticide is relatively expensive and can cost more than $500 per day for a typical plant such as processing 10 to 20 million gallons per day.

Pellets containing methoprene or a wettable dry granular insecticide including as an active ingredient bacillus thuringiensis (BTI), as are commonly used in wastewater treatment lagoons, may be a more cost effective alternative. For example, the methoprene carrying pellets may cost on the order of $75/day compared to an equivalent of $500/day for the liquid methoprene. The pellets are currently merely dispensed into lakes or lagoons where they sink to the bottom. Unfortunately, the methoprene pellets cannot be simply dispensed into the trickling filter.

A number of patents disclose devices for dispensing chemicals, such as, for example, U.S. Pat. No. 4,313,827 to Ratigan et al. which discloses a system for adding a disinfectant to a wastewater stream. A small portion of a wastewater stream is pumped into a tubular shaped diffuser area. The wastewater is forced though a nozzle and then mixed with high pressure liquid disinfectant. This mixture is then returned to the primary wastewater flow through circumferential holes in an inner conduit of a coaxially configured duct.

Also, U.S. Pat. No. 3,370,571 to Knapp, discloses a method and apparatus for dispensing an insecticide liquid. The apparatus comprises a container holding a mass of insecticide carrying plastic bodies through which water is passed. The water dislodges the insecticide from the plastic bodies thereby creating a liquid insecticide mixture. This liquid is sprayed onto livestock for insect control.

Unfortunately, there is still no effective apparatus or method for delivering granular or pellet type insecticides into wastewater, such as for a tricking filter. Accordingly, liquid insecticides are either used at a high cost, or the pests are simply tolerated.

### SUMMARY OF THE INVENTION

In view of the foregoing background, it is therefore an object of the present invention to provide an apparatus and method for cost effectively delivering insecticide to wastewater.

This and other objects, features, and advantages in accordance with the present invention are provided by an insecticide delivery apparatus for delivering insecticide from a mass of insecticide bearing bodies to wastewater. More particularly, the insecticide delivery apparatus may include an insecticide extraction chamber having an outlet adjacent a lower end thereof, and a screen adjacent the outlet for holding the mass of insecticide bearing bodies to partially fill the insecticide extraction chamber. The outlet is connected in fluid communication with the wastewater. In addition, the apparatus may also include a nozzle positioned adjacent an upper end of the insecticide extraction chamber for directing a water stream downwardly therefrom toward the mass of insecticide bearing bodies.

Moreover, an air control device may be connected in fluid communication with the insecticide extraction chamber for controlling a water level and associated head space so that the insecticide bearing bodies are at least partially submerged in the water. The bodies may be churned in the water by action of the stream to enhance delivery of insecticide into the water, and, thereafter into the wastewater.

The air control device may include a flow meter and an air bleed valve connected together in fluid communication. The apparatus may provide efficient and cost effective control of a number of insects, such as midge flies that are prevalent in a trickling filter of a typical wastewater treatment plant. In addition, this control of midge flies, for example, can be performed using a less expensive pellet type of insecticide.

The nozzle may alternately or additionally direct a flow of water to wash down interior surfaces of the insecticide extraction chamber above the mass of insecticide bearing bodies. Accordingly, any residue that would otherwise remain on the sidewalls is captured in the water.

The insecticide extraction chamber may include a tubular body having open upper and lower ends, and an upper cap and a lower cap covering the respective upper and lower open ends of the tubular body. The chamber may also include transparent portions to permit viewing of the water and insecticide mass levels inside the chamber. Indicating indicia may be provided on the tubular body to aid the user. The insecticide delivery apparatus may also include a mixing baffle downstream from the insecticide extraction chamber.

The insecticide delivery apparatus may also include a flow meter, an input valve and a pressure sensor connected upstream from the insecticide extraction chamber. A pH sensor may be provided for sensing pH of the wastewater, and for controlling the input valve. When the pH rises above a certain level, the insecticide's effectiveness may be substantially reduced. Accordingly, the delivery of insecticide can be suspended during these times.

Another aspect of the invention relates to a wastewater treatment plant of a type that includes a trickling filter. The treatment plant may also include the insecticide delivery apparatus described above and coupled to the trickling filter. In this embodiment, the insecticide may include at least one of methoprene and BTI, although other similar insecticides may also be used.

One method aspect of the invention is for delivering insecticide from a mass of insecticide bearing bodies to wastewater. The method may comprise directing a water stream downwardly through an insecticide extraction chamber and toward the mass of insecticide bearing bodies contained therein, and while controlling a water level and associated head space thereabove so that the insecticide bearing bodies are at least partially submerged in the water.

Another method aspect of the invention is for treating wastewater and includes processing wastewater though a trickling filter. In addition, the method may include delivering insecticide from a mass of insecticide bearing bodies to the wastewater in the trickling filter. This may be done by directing a water stream downwardly through an insecticide extraction chamber and toward the mass of insecticide bearing bodies contained therein, and while controlling a water level and associated head space thereabove so that the insecticide bearing bodies are at least partially submerged in the water.

### BRIEF DESCRIPTION OF THE DRAWINGS

FIG. 1 is a schematic block diagram of a wastewater treatment system including a trickling filter and the insecticide delivery apparatus in accordance with the invention.

FIG. 2 is a front elevational and view of the insecticide delivery apparatus as shown schematically in FIG. 1.

FIG. 3 is an enlarged portion of an alternate embodiment of the insecticide delivery apparatus in accordance with the invention.

FIG. 4 is an enlarged portion of another alternate embodiment of the insecticide delivery apparatus in accordance with the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and double prime notation are used to indicate similar elements in alternate embodiments.

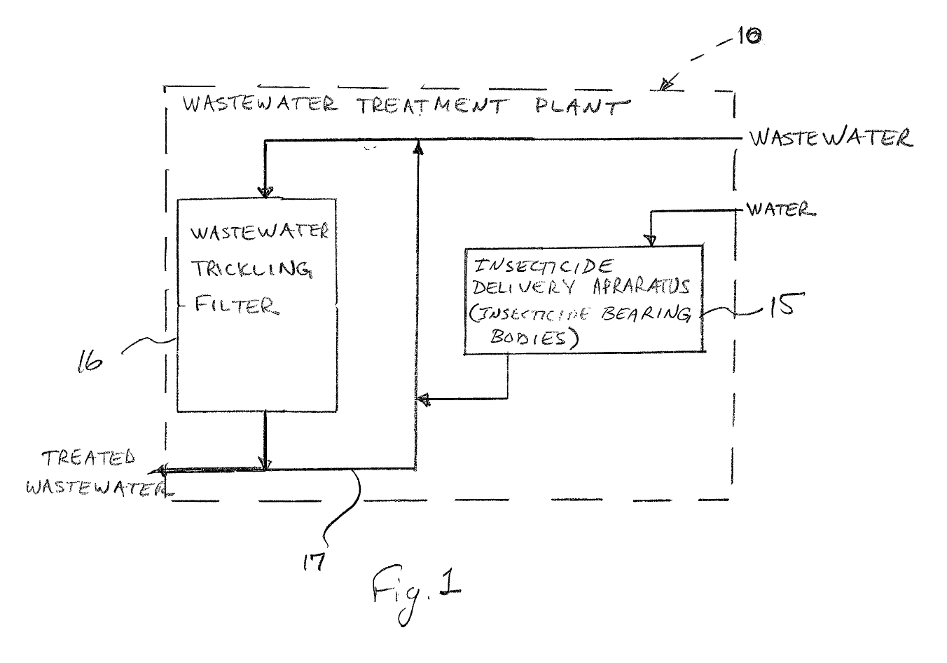

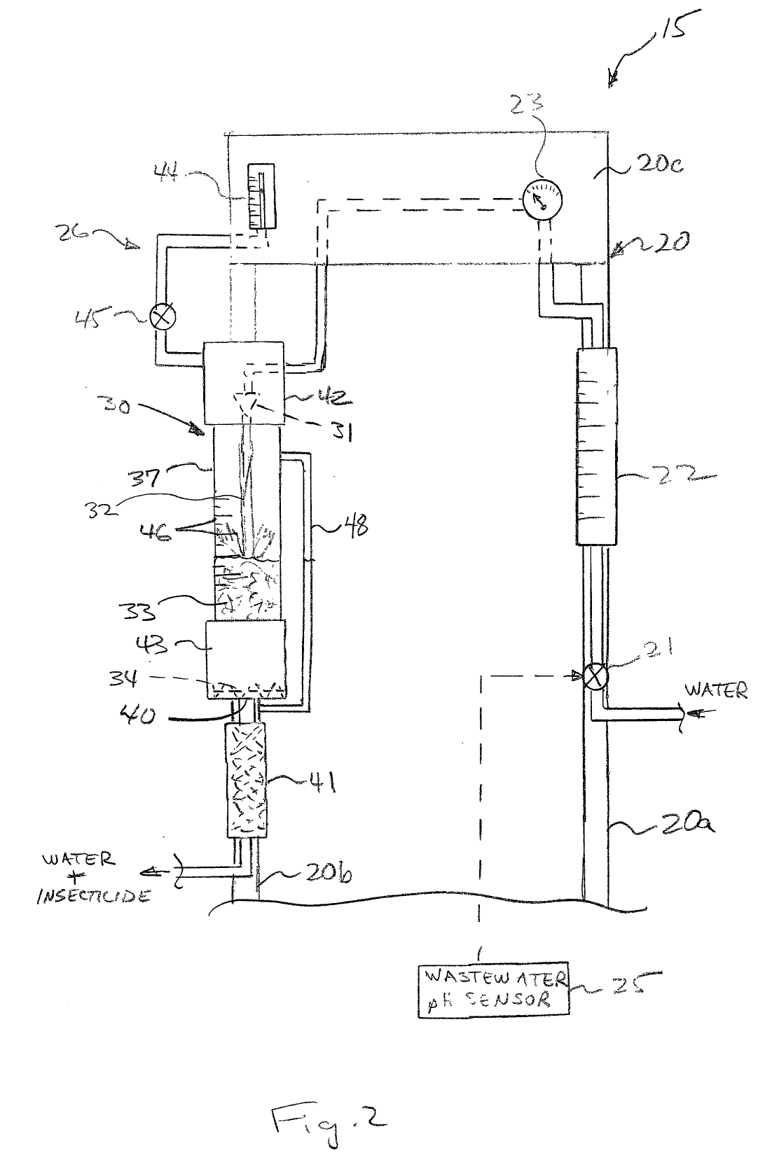

Referring now initially to FIGS. 1 and 2 a wastewater treatment plant 10 including the insecticide delivery apparatus 15 in accordance with the invention is now described. The wastewater treatment plant 10 illustratively includes a trickling filter 16 which receives a flow of input wastewater and delivers an output of treated wastewater. A recycle line 17 is also illustratively connected between the output and input of the trickling filter 16. Those of skill in the art will recognize that a typical wastewater treatment plant 10 includes a number of other components; however, so as not to obscure the description of the present invention, these other conventional components are not shown.

The insecticide bearing water from the output of the insecticide delivery apparatus 15 is illustratively coupled to the recycle line 17. Those of skill in the art will recognize that other arrangements for delivering the insecticide bearing water are also contemplated by the invention. In addition, the insecticide delivery apparatus 15 can be used in other applications. For example, the apparatus 15 may be readily used in conjunction with a treatment lagoon, clarifier, sludge drying bed, influent structure, for stagnant or standing water, or other areas of wastewater treatment facilities where pests are a problem. The illustrated use for supplying insecticide for a trickling filter 16 is a particularly advantageous application, and, as explained in further detail below, permits the use of less expensive granular or pellet type insecticides for this application rather than conventional and more expensive liquid insecticides.

The insecticide delivery apparatus 15 may include a rack or frame 20 to mount the other components. For example, the rack 20 may include a pair of vertical rails 20a, 20b and a panel 20c mounted to the upper ends thereof as shown in the illustrated embodiment. Such a rack or frame 20 can be conveniently located in a typical wastewater treatment plant 10 as will be appreciated by those skilled in the art.

The insecticide delivery apparatus 15 illustratively includes an insecticide extraction chamber 30, having a tubular shape and having an outlet 40 adjacent a lower end thereof. The chamber 30 may be provided by a transparent plastic tube 37, which is about four inches in diameter and about four feet long for a typical application. In the illustrated embodiment, the open upper and lower ends of the tube 37 are covered by respective upper and lower end caps 42 and 43. The tube 37 may also have indicating indicia 46 to aid in monitoring the water level and/or the quantity of the mass of insecticide bearing bodies 33.

The upper cap 43 may be removable allowing access to the interior of the insecticide extraction chamber 30. The indicia 46 may include minimum, maximum and intermediate levels, for example, to ensure the proper quantity of insecticide bearing bodies is added during initial filling, and also to ensure that the water level is proper in the chamber 30. The insecticide extraction chamber 30 may be initially filled approximately one third full with a mass of insecticide bearing bodies 33. The insecticide extraction chamber 30 also illustratively includes a screen 34 adjacent the outlet 40 for holding the mass of insecticide bearing bodies 33 in the insecticide extraction chamber 30.

The insecticide bearing bodies 33 for midge control may be of the type available from Wellmark International of Schaumburg, Ill. under the name STRIKE® Professional Midge Control. The active ingredient is methoprene. This chemical attacks the midge fly while it is in its larva stage and prevents its development into an adult fly. As a result, the insects die without breeding. The formula includes carbon, hydrogen and oxygen, in addition to methoprene, and therefore does not interfere with the necessary microbiological action in the trickling filter 16, for example. The life cycle of the midge fly is one to three weeks so it may typically take approximately two weeks to see a noticeable reduction in the midge fly population.

Of course, other similar insecticides may also be used as will be appreciated by those skilled in the art. For example, Becker Microbial of Plantation, Fla. offers a wettable dry granular insecticide under the designation AQUABAC™ that includes as an active ingredient bacillus thuringiensis or BTI.

The apparatus 15 also illustratively includes a nozzle 31 positioned adjacent an upper end of the insecticide extraction chamber 30 for directing a water stream 32 downwardly therefrom toward the mass of insecticide bearing bodies 33. The water supplied to the extraction chamber 30 may be clean water, such as from the municipal water supply or well, or the water may be a portion of the wastewater being treated, or the water may be a combination of these.

An air control device 26 may be connected in fluid communication with the insecticide extraction chamber 30 for controlling a wastewater level 35 and associated head space 36 thereabove so that the insecticide bearing bodies 33 are substantially covered with the wastewater 35 and are churned therein by action of the water stream 32 to enhance delivery of insecticide into the wastewater. The air control device may include a flow meter 44 and a control or air bleed valve 45 connected together in fluid communication, and with both connected in fluid communication with the upper end of the insecticide extraction chamber 30 as shown in the illustrated embodiment. In other embodiments, the air bleed valve 45 may be used by itself.

The insecticide delivery apparatus 15 may also include an input valve 21, a flow meter 22 and a pressure sensor 23 connected together in series and upstream from the insecticide extraction chamber 30 as shown in the illustrated embodiment. The input valve 21 may be adjusted to achieve the desired water flow rate through the insecticide extraction chamber 30. In addition, the insecticide delivery apparatus 15 may include a pH sensor 25 for sensing the pH of the wastewater and connected to the input valve 21 or other cut-off valve upstream of the insecticide extraction chamber 30. The pH sensor 25 can be used to stop delivery of the insecticide when the pH rises above a certain level indicative that the effectiveness of the insecticide will be substantially reduced.

Those of skill in the art will appreciate that other control schemes may also be used for controlling the delivery of water to the insecticide extraction chamber 30. For example, water could be supplied based upon a predetermined time schedule by incorporation of a timer connected to operate the input valve 21. Alternately or additionally, the input valve 21 could be closed should a sensed flow rate be above a predetermined level and/or below a predetermined level. Those of skill in the art will appreciate other equivalent control options as contemplated by the present invention.

A mixing baffle 41 is illustratively provided in the water flow path downstream of the outlet 40 of the insecticide extraction chamber 30. The mixing baffle 41 may encourage further release of the insecticide to the water from small granules which pass through the screen 34, and may further encourage mixing of the insecticide in the water.

Also provided in the illustrated embodiment is an overflow tube 48 which has an open upper end in communication with an upper portion of the insecticide extraction chamber 30. A lower open end of the overflow tube 48 is connected downstream of the screen 34. Accordingly, should the screen 34 become clogged, water will back up in the insecticide extraction chamber 30 until reaching the open upper end of the overflow tube 48. At that point, water can flow around the screen 34 by passing through the overflow tube 48 as will be readily appreciated by those skilled in the art.

As shown in the embodiment of FIG. 2, the nozzle 31 may be configured and positioned to direct a relatively direct downward water stream 32 toward the mass of insecticide bearing bodies 33. This may cause better agitation of the bodies to encourage release of the insecticide.

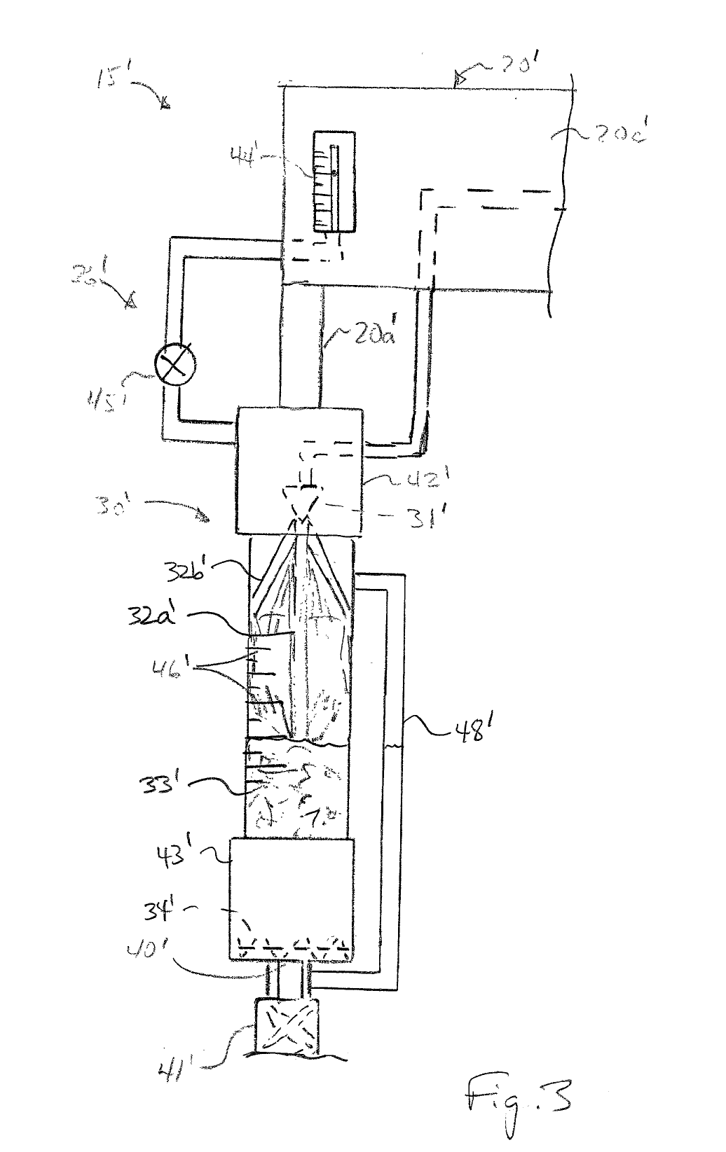

Turning now additionally to FIG. 3, another embodiment of the insecticide delivery apparatus 15′ includes an insecticide extraction chamber 30′ which, in turn, includes a nozzle to create both a direct downward water stream 32a′ as well as a peripheral stream or spray 32b′ which washes down the interior sidewalls of the chamber. Accordingly, any residue that would otherwise remain on the sidewalls is captured in the water stream 32b′. Those other elements of the embodiment of the insecticide delivery apparatus 15′ FIG. 3 which are similar to those of the embodiment in FIG. 2 are indicated with prime notation and need no further discussion herein.

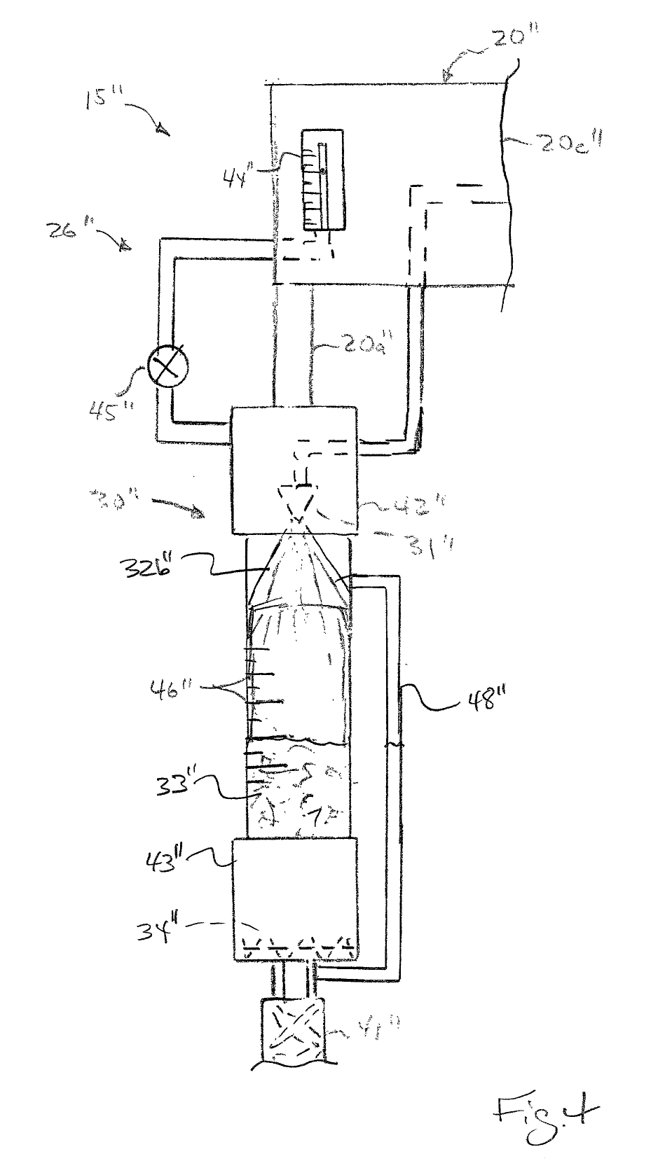

Referring now additionally to FIG. 4, yet another embodiment of the insecticide delivery apparatus 15″ is now described. In this embodiment, the nozzle 31″ produces only the peripheral stream 32b″. Accordingly, the interior sidewalls are washed down and sufficient water is supplied to adequately agitate the mass of insecticide bearing bodies 33″ as will appreciated by those skilled in the art. Those other elements of the embodiment of the insecticide delivery apparatus 15″ in FIG. 4 which are similar to those of the embodiments in FIGS. 2 and 3 are indicated with double prime notation and need no further discussion herein.

The invention is also directed to several methods. For clarity of explanation, reference is again directed to FIGS. 1 and 2, although those of skill in the art will understand that these methods are also reflected in the embodiments of FIGS. 3 and 4 and equivalents thereof. For example, one method aspect of the invention is for delivering insecticide from a mass of insecticide bearing bodies 33 to wastewater. The method may comprise directing a water stream 32 downwardly through an insecticide extraction chamber 30 and toward the mass of insecticide bearing bodies 33 contained therein, and while controlling a water level and associated head space thereabove so that the insecticide bearing bodies are at least partially submerged in the water.

Another method aspect of the invention is for treating wastewater and includes processing wastewater though a trickling filter 16. In addition, the method may include delivering insecticide from a mass of insecticide bearing bodies 33 to the wastewater in the trickling filter 16. This may be done by directing a water stream downwardly through an insecticide extraction chamber 30 and toward the mass of insecticide bearing bodies 33 contained therein, and while controlling a water level and associated head space thereabove so that the insecticide bearing bodies are at least partially submerged in the water.

Many modifications and other embodiments of the invention will come to the mind of one skilled in the art having the benefit of the teachings presented in the foregoing descriptions and the associated drawings. Accordingly, it is understood that the invention is not to be limited to the illustrated embodiments disclosed, and that the modifications and embodiments are intended to be included within the spirit and scope of the appended claims.

That which is claimed:

1. An insecticide delivery apparatus for delivering insecticide from a mass of insecticide bearing bodies to wastewater, the insecticide delivery apparatus comprising:
an insecticide extraction chamber having an outlet adjacent a lower end thereof for delivering insecticide containing water to the wastewater;
a screen adjacent the outlet of said insecticide extraction chamber for holding the mass of insecticide bearing bodies to partially fill said insecticide extraction chamber;
a nozzle positioned adjacent an upper end of said insecticide extraction chamber for directing a water stream downwardly therefrom toward the mass of insecticide bearing bodies; and
an air control device connected in fluid communication with said insecticide extraction chamber for controlling a water level and associated head space thereabove so that the insecticide bearing bodies are at least partially submerged in water and are churned therein by action of the water stream.

2. An insecticide delivery apparatus according to claim 1 wherein said nozzle further directs a flow of water to wash down interior surfaces of said insecticide extraction chamber above the mass of insecticide bearing bodies.

3. An insecticide delivery apparatus according to claim 1 wherein said air control device comprises a flow meter and an air bleed valve connected in fluid communication therewith.

4. An insecticide delivery apparatus according to claim 1 wherein said insecticide extraction chamber comprises transparent portions to permit viewing therethrough.

5. An insecticide delivery apparatus according to claim 4 further comprising level indicating indicia on said insecticide extraction chamber.

6. An insecticide delivery apparatus according to claim 1 further comprising a flow meter and an input valve connected upstream from said insecticide extraction chamber.

7. An insecticide delivery apparatus according to claim 1 further comprising a pressure sensor connected upstream from said insecticide extraction chamber.

8. An insecticide delivery apparatus according to claim 1 further comprising a pH sensor for sensing pH of the wastewater, and a cut-off valve upstream of said insecticide extraction chamber and operating responsive to said pH sensor.

9. An insecticide delivery apparatus according to claim 1 further comprising a mixing baffle downstream from said insecticide extraction chamber.

10. An insecticide delivery apparatus according to claim 1 wherein said insecticide extraction chamber further comprises a tubular body having open upper and lower ends, and an upper cap and a lower cap covering the respective upper and lower open ends of said tubular body.

11. An insecticide delivery apparatus for delivering insecticide from a mass of insecticide bearing bodies to wastewater, the insecticide delivery apparatus comprising:
an insecticide extraction chamber having an outlet adjacent a lower end thereof for delivering insecticide containing water to the wastewater;
a screen adjacent the outlet of said insecticide extraction chamber for holding the mass of insecticide bearing bodies to partially fill said insecticide extraction chamber;
a nozzle positioned adjacent an upper end of said insecticide extraction chamber for directing a water stream downwardly therefrom toward the mass of insecticide bearing bodies, and for also directing a flow of water to wash down interior surfaces of said insecticide extraction chamber; and
a flow meter and an air bleed valve connected in fluid communication with said insecticide extraction chamber for controlling a water level and associated head space thereabove so that the mass of insecticide bearing bodies are at least partially submerged in the water.

12. An insecticide delivery apparatus according to claim 11 wherein said insecticide extraction chamber comprises transparent portions to permit viewing therethrough.

13. An insecticide delivery apparatus according to claim 12 further comprising level indicating indicia on said insecticide extraction chamber.

14. An insecticide delivery apparatus according to claim 11 further comprising a flow meter and an input valve connected upstream from said insecticide extraction chamber.

15. An insecticide delivery apparatus according to claim 11 further comprising a pressure sensor connected upstream from said insecticide extraction chamber.

16. An insecticide delivery apparatus according to claim 11 further comprising a pH sensor for sensing pH of the wastewater, and a cut-off valve upstream of said insecticide extraction chamber and operating responsive to said pH sensor.

17. An insecticide delivery apparatus according to claim 11 further comprising a mixing baffle downstream from said insecticide extraction chamber.

18. An insecticide delivery apparatus according to claim 11 wherein said insecticide extraction chamber further comprises a tubular body having open upper and lower ends, and an upper cap and a lower cap covering the respective upper and lower open ends of said tubular body.

19. An insecticide delivery apparatus for delivering insecticide from a mass of insecticide bearing bodies to wastewater, the insecticide delivery apparatus comprising:
an insecticide extraction chamber having an outlet adjacent a lower end thereof for delivering insecticide containing water to the wastewater;
a screen adjacent the outlet of said insecticide extraction chamber for holding the mass of insecticide bearing bodies to partially fill said insecticide extraction chamber;
a nozzle positioned adjacent an upper end of said insecticide extraction chamber for directing a flow of water to wash down interior surfaces of said insecticide extraction chamber above the mass of insecticide bearing bodies; and
an air control device connected in fluid communication with said insecticide extraction chamber for controlling a water level and associated head space thereabove so that the mass of insecticide bearing bodies are at least partially submerged in the water.

20. An insecticide delivery apparatus according to claim 19 wherein said air control device comprises a flow meter and an air bleed valve connected in fluid communication therewith.

21. An insecticide delivery apparatus according to claim 19 wherein said insecticide extraction chamber comprises transparent portions to permit viewing therethrough.

22. An insecticide delivery apparatus according to claim 21 further comprising level indicating indicia on said insecticide extraction chamber.

23. An insecticide delivery apparatus according to claim 19 further comprising a flow meter and an input valve connected upstream from said insecticide extraction chamber.

24. An insecticide delivery apparatus according to claim 19 further comprising a pressure sensor connected upstream from said insecticide extraction chamber.

25. An insecticide delivery apparatus according to claim 19 further comprising a pH sensor for sensing pH of the wastewater, and a cut-off valve upstream of said insecticide extraction chamber and operating responsive to said pH sensor.

26. An insecticide delivery apparatus according to claim 19 further comprising a mixing baffle downstream from said insecticide extraction chamber.

27. An insecticide delivery apparatus according to claim 19 wherein said insecticide extraction chamber further comprises a tubular body having open upper and lower ends, and an upper cap and a lower cap covering the respective upper and lower open ends of said tubular body.

28. A wastewater treatment plant comprising:
a trickling filter for processing wastewater; and
an insecticide delivery apparatus for delivering insecticide from a mass of insecticide bearing bodies to wastewater in said tricking filter, said insecticide delivery apparatus comprising
an insecticide extraction chamber having an outlet adjacent a lower end thereof for delivering insecticide containing water to the wastewater,
a screen adjacent the outlet of said insecticide extraction chamber for holding the mass of insecticide bearing bodies to partially fill said insecticide extraction chamber, and
a nozzle positioned adjacent an upper end of said insecticide extraction chamber for directing water downwardly therefrom toward the mass of insecticide bearing bodies.

29. A wastewater treatment plant according to claim 28 wherein said insecticide bearing bodies comprise at least one of methoprene and BTI.

30. A wastewater treatment plant according to claim 28 wherein said nozzle further directs a flow of water to wash down interior surfaces of said insecticide extraction chamber above the mass of insecticide bearing bodies.

31. A wastewater treatment plant according to claim 28 further comprising an air control device connected in fluid communication with said insecticide extraction chamber for controlling a water level and associated head space thereabove so that the insecticide bearing bodies are at least partially submerged in the water.

32. A wastewater treatment plant according to claim 31 wherein said air control device further comprises a flow meter and an air bleed valve connected in fluid communication therewith.

33. A wastewater treatment plant according to claim 28 further comprising a pH sensor for sensing pH of the wastewater, and a cut-off valve upstream of said insecticide extraction chamber and operating responsive to said pH sensor.

34. A wastewater treatment plant according to claim 28 wherein said insecticide extraction chamber further comprises a tubular body having open upper and lower ends, and an upper cap and a lower cap covering the respective upper and lower open ends of said tubular body.

35. A method for delivering insecticide from a mass of insecticide bearing bodies to wastewater, the method comprising:
directing a water stream downwardly through an insecticide extraction chamber containing the mass of insecticide bearing bodies and out an outlet to the wastewater; and
while controlling a water level and associated head space thereabove in the insecticide extraction chamber so that the insecticide bearing bodies are at least partially submerged in the water.

36. A method according to claim 35 further comprising directing a flow of water to wash down interior surfaces of the insecticide extraction chamber above the mass of insecticide bearing bodies.

37. A method according to claim 35 wherein the insecticide bearing bodies comprise at least one of methoprene and BTI.

38. A method according to claim 35 further comprising controlling a flow of water into the insecticide extraction chamber.

39. A method according to claim 38 further comprising sensing pH of the wastewater and stopping the flow of water to the insecticide extraction chamber based upon the sensed pH.

40. A method for treating wastewater comprising:
processing wastewater though a trickling filter; and
delivering insecticide from a mass of insecticide bearing bodies to the wastewater in the trickling filter by
directing a water stream downwardly through the mass of insecticide bearing bodies contained in an insecticide extraction chamber and out an outlet to the wastewater, and
while controlling a wastewater level and associated head space thereabove in the insecticide extraction chamber so that the insecticide bearing bodies are at least partially submerged in the water.

41. A method according to claim 40 further comprising directing a flow of water to wash down interior surfaces of the insecticide extraction chamber above the mass of insecticide bearing bodies.

42. A method according to claim 40 wherein the insecticide bearing bodies comprise at least one of methoprene and BTI.

43. A method according to claim 40 further comprising controlling a flow of water into the insecticide extraction chamber.

44. A method according to claim 43 further comprising sensing pH of the wastewater and stopping the flow of water to the insecticide extraction chamber based upon the sensed pH.
